(19) United States
(12) Patent Application Publication
(10) Pub. No.: US 2025/0303983 A1
(43) Pub. Date: Oct. 2, 2025

(54) VEHICLE ONBOARD CONTROL METHOD, SYSTEM, AND RELATED DEVICE BASED ON MULTI-LEVEL MUSIC INFORMATION

(71) Applicant: AAC Acoustic Technologies (Shanghai) Co., Ltd., Shanghai (CN)

(72) Inventors: Zhu Liu, Shanghai (CN); Lianwu Chen, Shanghai (CN); Xuejing Sun, L.A., CA (US)

(21) Appl. No.: 18/791,462

(22) Filed: Aug. 1, 2024

Related U.S. Application Data
(63) Continuation of application No. PCT/CN2024/084175, filed on Mar. 27, 2024.

(51) Int. Cl. B60R 16/023; G10H 1/00

(52) U.S. Cl. CPC B60R 16/023; G10H 1/0008; G10H 2210/061; G10H 2210/071; G10H 2210/076; G10H 2250/311

(57) ABSTRACT

The present disclosure provides a vehicle onboard control method, a system, and a related device based on multi-level music information. The method includes: acquiring music signals; analyzing the music signals and extracting music analysis content including basic features, change points, beat points, a music structure, music attributes, and a music style from the music signals; and generating, based on the music analysis content, control signals according to a preset generation rule template, and transmitting the control signals to a vehicle onboard system to achieve control of vibration and lighting.

### CROSS REFERENCE TO RELATED APPLICATIONS

The present application is a continuation of PCT Patent Application No. PCT/CN2024/084175, filed Mar. 27, 2024, which is incorporated by reference herein in its entirety.

### TECHNICAL FIELD

The present disclosure relates to the field of signal processing, and in particular to a vehicle onboard control method, a system, and a related device based on multi-level music information.

### BACKGROUND

With the continuous development of vehicle onboard technology and the increasing demand for in-car audio experience from users, multimodal audio technology that provides seat vibration and lighting rhythm based on music information is becoming increasingly mature. Music information extraction technology is one of the key technologies used to achieve seat and lighting control based on music information. This technology can extract various useful information from music, such as rhythm, melody, attributes, emotions, etc., using audio signal processing and feature extraction methods, and the information can be used to control the seats and lighting. Moreover, seat and lighting control technology is another key technology for achieving changes in the seat and lighting based on music information. At present, many vehicles have the function of seat and lighting control, which can create a more immersive audio experience by adjusting the vibration frequency, intensity and direction of the seat, as well as the brightness, color, or the like of the lights.

Most of the existing vehicle onboard lighting rhythm and seat vibration systems based on music information achieve control of the frequency and intensity of vibration, as well as the brightness and color of the lights based on basic features such as music energy, rhythm, timbre, and the like.

However, although existing vehicle onboard systems can enrich the in-car audio experience to a certain extent, due to the lack of a more comprehensive analysis of music signals, signals for controlling the seat and lighting are relatively simple, and the final experience effect is relatively monotonous. In addition, existing solutions generally control the seats and lighting separately, without further combining the control of the seats and lighting, which makes the consistency of the user experience not very good.

Therefore, it is necessary to provide a new vehicle onboard control method to address the above problems.

### SUMMARY

The technical problem to be solved by the present disclosure is to provide a vehicle onboard control method, a system, and a related device based on multi-level music information, in order to control vibration and lighting effects more in line with the characteristics of music.

To solve the above-mentioned technical problem, in the first aspect, the present disclosure provides a vehicle onboard control method based on multi-level music information, including:
acquiring music signals;
analyzing the music signals and extracting music analysis content including basic features, change points, beat points, a music structure, music attributes, and a music style from the music signals; and
generating, based on the music analysis content, control signals according to a preset generation rule template, and transmitting the control signals to a vehicle onboard system to achieve control of vibration and lighting.

As an improvement, extracting the music analysis content including the basic features from the music signals, includes:
dividing the music signals into a plurality of music frames, and analyzing and marking predetermined to-be-acquired basic features in each music frame of the plurality of music frames;
where a basic feature \vec{f}ᵢ extracted from an i-th music frame meets:

\vec{f}ᵢ=[f₁(i),f₂(i), . . . ,f_{M}(i)];
M refers to a number of types of the predetermined to-be-acquired basic features;
in response to the music signals including Nf music frames, a set F of the basic features meets:

F=[\vec{f}₁,\vec{f}₂, . . . , \vec{f}_{Nf}].

As an improvement, extracting the music analysis content including the change points from the music signals, includes:
determining whether a current music frame includes a change point according to a degree of energy change in time domain or frequency domain of a music frame previous to the current music frame and of a music frame next to the current music frame; and
in response to the current music frame including the change point, extracting the change point from the current music frame;
in response to the music signals including No change points, a set O of the change points meets:

O=[o₁,o₂, . . . ,o_{N}_{ₒ}]

As an improvement, extracting the music analysis content including the beat points from the music signals, includes:
tracking beats of the music signals using a preset neural network, and marking the beat and downbeats;
in response to the music signals including Nb beats and Nd downbeats, a set B of the beats meets:

B=[b₁,b₂, . . . b_{N}_{_{b}}]; and
a set D of the downbeats meets:

D=[d₁,d₂, . . . ,d_{N}_{_{d}}].

As an improvement, extracting the music analysis content including the music structure from the music signals, includes:
segmenting the music signals according to structural information of the music signals, to obtain a plurality of music segments;
where an i-th music segment \vec{s}ᵢ of the music signals meets:

\vec{s}ᵢ=[t_{begin}(i),t_{end}(i)];
where t_{begin}(i) refers to starting time of the music segment \vec{s}ᵢ, and t_{end}(i) refers to ending time of the music segment \vec{s}ᵢ, in response to there being Ns music segments, a set S of the music segments meets:

S=[\vec{s}₁,\vec{s}₂, . . . ,\vec{s}_{Ns}]; and
in response to a type of the i-th music segment being ki, segment type information K of the music signals meets:

K=[k₁,k₂, . . . ,k_{Ns}].

As an improvement, extracting the music analysis content including the music attributes from the music signals, includes:
dividing the music signals into a plurality of music bars, and calculating rhythm intensities based on a respective number of notes played in each music bar of the plurality of music bars;
where an i-th music bar \vec{r}ᵢ of the music signals meets:

\vec{r}ᵢ=[t_{begin}(i),t_{end}(i)];
in response to a number of the plurality of music bars being Nr, a set R of the music bars meets:

R=[\vec{r}₁,\vec{r}₂, . . . ,\vec{r}_{Nr}]; and
in response to a rhythm intensity of the i-th music bar being mi, rhythm intensity information M of the music signals meets:

M=[m₁,m₂, . . . ,m_{Nr}].

As an improvement, generating, based on the music analysis content, the control signals according to the preset generation rule template, includes:
determining the music style C of the music signals, and generating the preset generation rule template according to the set R of the music bars, the rhythm intensity information M, the set S of the music segments, the segment type information K and the music style C {R, M, S, K, C};
generating, based on the set O of the change points, the set B of the beats and the set D of the downbeats {O, B, D}, time point control signals T for vibration control according to the preset generation rule template;
generating, based on the set F of the basic features and the time point control signals T, vector control signals P for lighting control according to the preset generation rule template; and
outputting the time point control signals T and the vector control signals P as the control signals.

In the second aspect, the present disclosure further provides a vehicle onboard control system based on multi-level music information, including:
a data acquisition module, configured to acquire music signals;
a music analysis module, configured to analyze the music signals and extract music analysis content including basic features, change points, beat points, a music structure, music attributes, and a music style from the music signals; and
a control module, configured to generate, based on the music analysis content, control signals according to a preset generation rule template, and to transmit the control signals to a vehicle onboard system to achieve control of vibration and lighting.

In the third aspect, the present disclosure further provides a computer device, including: a memory, at least one processor, and a vehicle onboard control program based on multi-level music information stored in the memory, which, when executed by the at least one processor, causes the at least one processor to perform operations of a vehicle onboard control method based on multi-level music information. The method includes:
acquiring music signals;
analyzing the music signals and extracting music analysis content including basic features, change points, beat points, a music structure, music attributes, and a music style from the music signals; and
generating, based on the music analysis content, control signals according to a preset generation rule template, and transmitting the control signals to a vehicle onboard system to achieve control of vibration and lighting.

As an improvement, extracting the music analysis content including the basic features from the music signals, includes:
dividing the music signals into a plurality of music frames, and analyzing and marking predetermined to-be-acquired basic features in each music frame of the plurality of music frames;
where a basic feature \vec{f}ᵢ extracted from an i-th music frame meets:

\vec{f}ᵢ=[f₁(i),f₂(i), . . . ,f_{M}(i)];
M refers to a number of types of the predetermined to-be-acquired basic features;
in response to the music signals including Nf music frames, a set F of the basic features meets:

F=[\vec{f}₁,\vec{f}₂, . . . , \vec{f}_{Nf}].

As an improvement, extracting the music analysis content including the change points from the music signals, includes:
determining whether a current music frame includes a change point according to a degree of energy change in time domain or frequency domain of a music frame previous to the current music frame and of a music frame next to the current music frame; and
in response to the current music frame including the change point, extracting the change point from the current music frame;
in response to the music signals including No change points, a set O of the change points meets:

O=[o₁,o₂, . . . ,o_{N}_{ₒ}].

As an improvement, extracting the music analysis content including the beat points from the music signals, includes:
tracking beats of the music signals using a preset neural network, and marking the beat and downbeats;
in response to the music signals including Nb beats and Nd downbeats, a set B of the beats meets:

B=[b₁,b₂, . . . b_{N}_{_{b}}]; and
a set D of the downbeats meets:

D=[d₁,d₂, . . . ,d_{N}_{_{d}}].

As an improvement, extracting the music analysis content including the music structure from the music signals, includes:
segmenting the music signals according to structural information of the music signals, to obtain a plurality of music segments;
where an i-th music segment of the music signals meets:

\vec{s}ᵢ=[t_{begin}(i),t_{end}(i)];
where t_{begin}(i) refers to starting time of the music segment \vec{s}ᵢ, and t_{end}(i) refers to ending time of the music segment \vec{s}ᵢ, in response to there being Ns music segments, a set S of the music segments meets:

S=[\vec{s}₁,\vec{s}₂, . . . ,\vec{s}_{Ns}]; and
in response to a type of the i-th music segment being ki, segment type information K of the music signals meets:

K=[k₁,k₂, . . . ,k_{Ns}].

As an improvement, extracting the music analysis content including the music attributes from the music signals, includes:
dividing the music signals into a plurality of music bars, and calculating rhythm intensities based on a respective number of notes played in each music bar of the plurality of music bars;
where an i-th music bar of the music signals meets:

\vec{r}ᵢ=[t_{begin}(i),t_{end}(i)];
in response to a number of the plurality of music bars being Nr, a set R of the music bars meets:

R=[\vec{r}₁,\vec{r}₂, . . . ,\vec{r}_{Nr}]; and
in response to a rhythm intensity of the i-th music bar being mi, rhythm intensity information M of the music signals meets:

M=[m₁,m₂, . . . ,m_{Nr}].

As an improvement, generating, based on the music analysis content, the control signals according to the preset generation rule template, includes:
determining the music style C of the music signals, and generating the preset generation rule template according to the set R of the music bars, the rhythm intensity information M, the set S of the music segments, the segment type information K and the music style C {R, M, S, K, C};
generating, based on the set O of the change points, the set B of the beats and the set D of the downbeats {O, B, D}, time point control signals T for vibration control according to the preset generation rule template;
generating, based on the set F of the basic features and the time point control signals T, vector control signals P for lighting control according to the preset generation rule template; and
outputting the time point control signals T and the vector control signals P as the control signals.

In the fourth aspect, the present disclosure further provides a computer-readable storage medium, configured to store a vehicle onboard control program based on multi-level music information, which, when executed by at least one processor, causes the at least one processor to perform operations of the vehicle onboard control method based on multi-level music information as illustrated above.

Compared with the related technologies, the vehicle onboard control method based on multi-level music information provided by the present disclosure includes: acquiring music signals; analyzing the music signals and extracting music analysis content including basic features, change points, beat points, a music structure, music attributes, and a music style from the music signals; and generating, based on the music analysis content, control signals according to a preset generation rule template, and transmitting the control signals to a vehicle onboard system to achieve control of vibration and lighting. This method uses multi-level music information including the basic features, the change points, the beat points, the music structure, the music attributes, the music style, and the like of audio, and generates, based on the information, the control signals for controlling the vibration of seat and rhythm of lighting more in line with the characteristics of music in the vehicle onboard system, thereby providing users a more immersive in-car audio experience.

### BRIEF DESCRIPTION OF DRAWINGS

For clearer descriptions of the technical solutions in the embodiments of the present disclosure, drawings that are to be referred for description of the embodiments are briefly described hereinafter. Apparently, the drawings described hereinafter merely illustrate some embodiments of the present disclosure. Persons of ordinary skill in the art can derive other drawings based on the drawings described herein without any creative effort.

FIG. 1 is a flowchart of the operations of the vehicle onboard control method based on multi-level music information according to some embodiments of the present disclosure.

FIG. 2 is a schematic diagram of a structure of the vehicle onboard control system based on multi-level music information according to some embodiments of the present disclosure.

FIG. 3 is a schematic diagram of a structure of the computer device according to some embodiments of the present disclosure.

### DETAILED DESCRIPTION OF EMBODIMENTS

The following will provide a clear and complete description of the technical solution in the embodiments of the present disclosure, in conjunction with the accompanying drawings. Obviously, the described embodiments are only a part of the embodiments of the present disclosure, not all of them. Based on the embodiments in the present disclosure, all other embodiments obtained by those skilled in the art without creative labor fall within the scope of protection of the present disclosure.

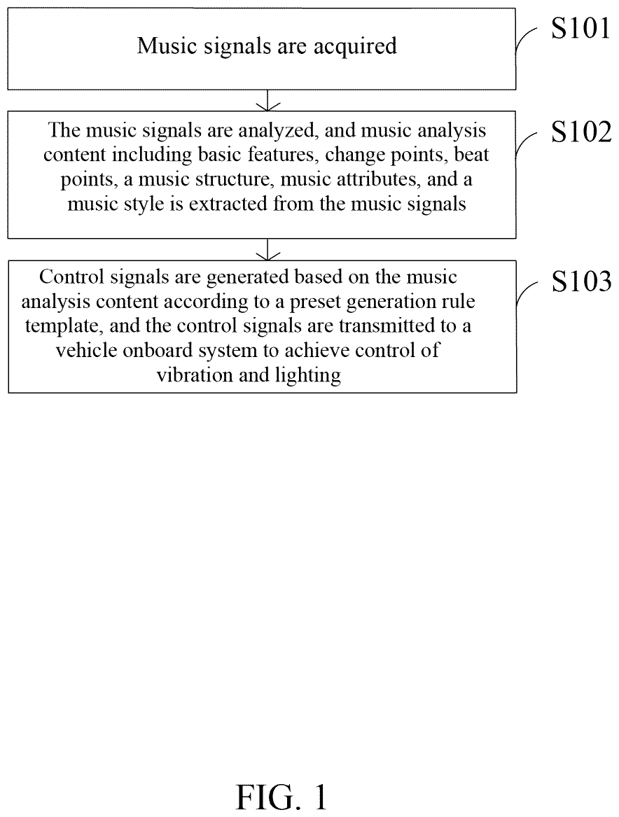

Referring to FIG. 1, FIG. 1 is a flowchart of the operations of the vehicle onboard control method based on multi-level music information according to some embodiments of the present disclosure. The method includes the following operations.

At S101, music signals are acquired.

At S102, the music signals are analyzed, and music analysis content including basic features, change points, beat points, a music structure, music attributes, and a music style is extracted from the music signals.

At S103, control signals are generated based on the music analysis content according to a preset generation rule template, and the control signals are transmitted to a vehicle onboard system to achieve control of vibration and lighting.

In some embodiments, the music signals at S101 may be acquired using a plurality of methods, including real-time/offline analysis in the vehicle, calling cloud services, or being saved, in the form of metadata, in the song files during production, which are not specifically limited in the embodiments of the present disclosure.

The operation S102 in the embodiments of the present disclosure is used to extract, from bottom to top, multi-level music analysis content from the basic features at the level of frame to the style classification of the entire song.

In some embodiments, the operation of extracting the music analysis content including the basic features from the music signals includes: dividing the music signals into a plurality of music frames, for example 10 ms per frame, and analyzing and marking predetermined to-be-acquired basic features in each music frame. A basic feature \vec{f}ᵢ extracted from an i-th music frame meets:

\vec{f}ᵢ=[f₁(i),f₂(i), . . . ,f_{M}(i)];
where M refers to a number of types of the predetermined to-be-acquired basic features.

In response to the music signals including Nf music frames, a set F of the basic features meets:

F=[\vec{f}₁,\vec{f}₂, . . . , \vec{f}_{Nf}].

In some embodiments, the operation of extracting the music analysis content including the change points from the music signals includes:
determining whether a current music frame includes a change point according to a degree of energy change in time domain or frequency domain of a music frame previous to the current music frame and of a music frame next to the current music frame, where the change point may be in a form of a starting point of drumming or of the sound of other musical instruments. In response to the current music frame including the change point, extracting the change point from the current music frame. In response to the music signals including No change points, a set O of the change points meets:

O=[o₁,o₂, . . . ,o_{N}_{ₒ}]

In some embodiments, the operation of extracting the music analysis content including the beat points from the music signals includes:
tracking beats of the music signals using a preset neural network, and marking the beat and downbeats. In response to the music signals including Nb beats and Nd downbeats, a set B of the beats meets:

B=[b₁,b₂, . . . b_{N}_{_{b}}]; and
a set D of the downbeats meets:

D=[d₁,d₂, . . . ,d_{N}_{_{d}}].

In some embodiments, the operation of extracting the music analysis content including the music structure from the music signals includes:
segmenting the music signals according to structural information of the music signals, to obtain a plurality of music segments. The music signals may be segmented into Introduction, Verse, Chorus, Bridge, Outro, and the like. An i-th music segment of the music signals meets:

\vec{s}ᵢ=[t_{begin}(i),t_{end}(i)];
where t_{begin}(i) refers to starting time of the music segment \vec{s}ᵢ and t_{end}(i) refers to ending time of the music segment \vec{s}ᵢ. In response to there being Ns music segments, a set S of the music segments meets:

S=[\vec{s}₁,\vec{s}₂, . . . ,\vec{s}_{Ns}]; and

in response to a type of the i-th music segment being ki, segment type information K of the music signals meets:

K=[k₁,k₂, . . . ,k_{Ns}].

In some embodiments, the operation of extracting the music analysis content including the music attributes from the music signals includes:
dividing the music signals into a plurality of music bars, and calculating rhythm intensities based on a respective number of notes played in each music bar. An i-th music bar \vec{r}ᵢ of the music signals meets:

\vec{r}ᵢ=[t_{begin}(i),t_{end}(i)];

In response to a number of the plurality of music bars being Nr, a set R of the music bars meets:

R=[\vec{r}₁,\vec{r}₂, . . . ,\vec{r}_{Nr}]; and
in response to a rhythm intensity of the i-th music bar being mi, rhythm intensity information M of the music signals meets:

M=[m₁,m₂, . . . ,m_{Nr}].

In some embodiments, the operation of generating, based on the music analysis content, the control signals according to the preset generation rule template includes:
determining the music style C of the music signals, such as pop, rock, jazz, folk, or the like, where the music style may be identified using signal processing or deep learning methods; and generating the preset generation rule template according to the set of the music bars, the rhythm intensity information, the set of the music segments, the segment type information and the music style {R, M, S, K, C};
generating, based on the set of the change points, the set of the beats and the set of the downbeats {O, B, D}, time point control signals T for vibration control according to the preset generation rule template;
generating, based on the set F of the basic features and the time point control signals T, vector control signals P for lighting control according to the preset generation rule template; and
outputting the time point control signals T and the vector control signals P as the control signals.

When Nc control signals are generated for an entire song (music signals), the control signals may be represented by:

T=[t₁,t₂, . . . ,t_{Nc}], and

P=[\vec{p}₁,\vec{p}₂, . . . ,\vec{p}_{Nc}].

As an example, with the pre-designed function func_mode(mᵢ, kᵢ, C), a template value wi for an introduction of a folk and another template value wi for a chorus of a pop song different from each other may be obtained, and then different methods for generating the control signals are used:

Tᵢ=func_time_{w}_{ᵢ}(Oᵢ,Bᵢ,Dᵢ), and

Pᵢ=func_vec_{w}_{ᵢ}(Fᵢ,Oᵢ,Bᵢ,Dᵢ)

In this way, different time point control signals and vector control signals can be generated using the preset generation rule templates.

It is noted that because the template corresponding to the time point control signals is different from that corresponding to the vector control signal, in practice, different templates may be selected, according to the rhythm intensity of bars of the music, types of the segments, and types of the music styles, to generate corresponding signals. For example, control signals of soothing style may be generated for an introduction of a folk. The method of func_time_{w}_{ᵢ} may only select the change points corresponding to downbeats for the preset generation rule template, and the method of func_vec_{w}_{ᵢ} may generate the preset generation rule template based on the energy of change points and timbre in the basic features, thereby generating gentle vibration control signals or soft lighting control signals.

For a chorus of a pop song, the method of

$${func\_time}_{{w}_{i}}$$

may select a set of time points corresponding to change points and beats for the preset generation rule template, and the method of

$${func\_vec}_{{w}_{i}}$$

may generate the preset generation rule template based on the energy of audio and types of the time points, and then slight vibration control signals and soft lighting control signals are generated based on the change points. Regarding the beat points, vibration control signals of different intensities and bright lighting control signals are generated according to types of the rhythm intensity of bars of the chorus.

Moreover, the two types of signals may be generated separately according to different corresponding rules or be combined to complement each other. For example, the rhythm of the lighting may be controlled using the beat change points, and the vibration of seats may be controlled using the downbeat change points. By cooperation of the lighting change and seat vibration, the beat points and downbeat points of the music can be better reflected, thereby improving the immersion of the audio experience in the vehicle.

Compared with the related technologies, the vehicle onboard control method based on multi-level music information provided by the present disclosure includes: acquiring music signals; analyzing the music signals and extracting music analysis content including basic features, change points, beat points, a music structure, music attributes, and a music style from the music signals; and generating, based on the music analysis content, control signals according to a preset generation rule template, and transmitting the control signals to a vehicle onboard system to achieve control of vibration and lighting. This method uses multi-level music information including the basic features, the change points, the beat points, the music structure, the music attributes, the music style, and the like of audio, and generates, based on the information, the control signals for controlling the vibration of seat and rhythm of lighting more in line with the characteristics of music in the vehicle onboard system, thereby providing users a more immersive in-car audio experience.

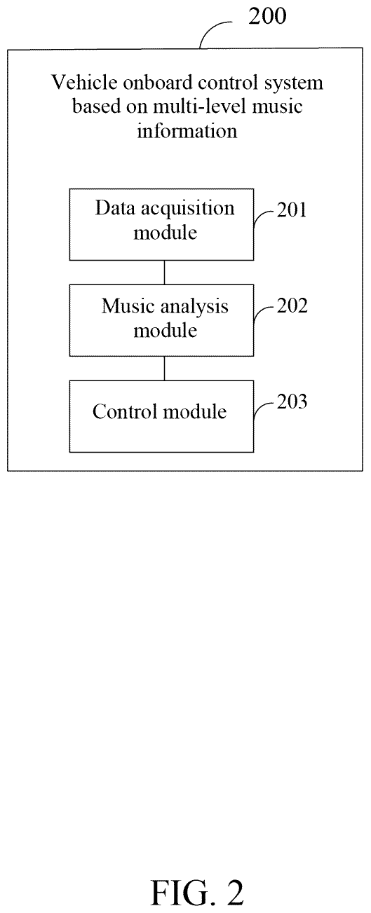

Embodiments of the present disclosure further provide a vehicle onboard control system based on multi-level music information. Referring to FIG. 2, FIG. 2 is a schematic diagram of a structure of the vehicle onboard control system based on multi-level music information according to some embodiments of the present disclosure. The system 200 includes:
a data acquisition module 201, configured to acquire music signals;
a multi-level music analysis module 202, configured to analyze the music signals and extract music analysis content including basic features, change points, beat points, a music structure, music attributes, and a music style from the music signals; and
a control module 203, configured to generate, based on the music analysis content, control signals according to a preset generation rule template, and to transmit the control signals to a vehicle onboard system to achieve control of vibration and lighting.

The vehicle onboard control system 200 based on multi-level music information can implement the operations of the vehicle onboard control method based on multi-level music information as illustrated above, and can achieve the same technical effects. Reference can be made to the above illustration, and will not be repeated here.

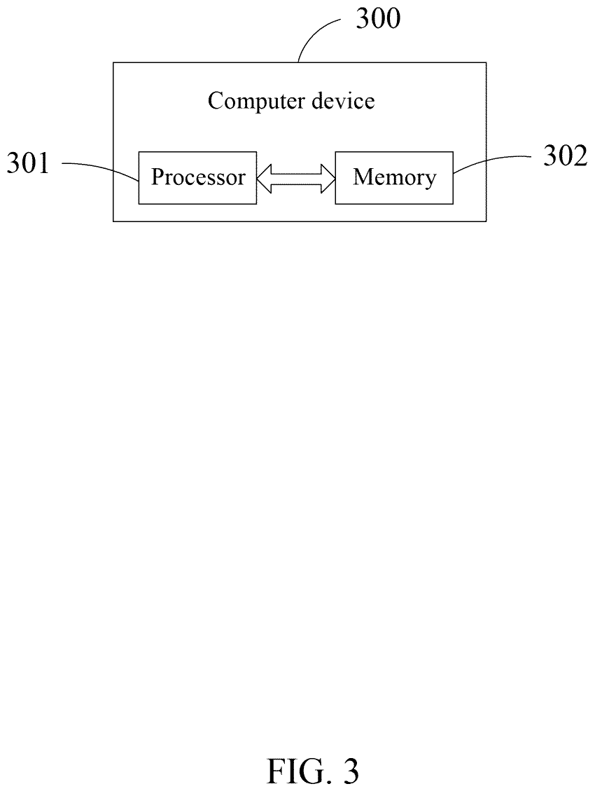

Embodiments of the present disclosure further provide a computer device. Referring to FIG. 3, FIG. 3 is a schematic diagram of a structure of the computer device according to some embodiments of the present disclosure. The computer device 300 includes: a memory 302, at least one processor 301, and a vehicle onboard control program based on multi-level music information stored in the memory 302 that is executable by the at least one processor 301.

The at least one processor 301 can call the vehicle onboard control program based on multi-level music information stored in the memory 302, thereby performing the operations of the vehicle onboard control method based on multi-level music information provided in some embodiments of the present disclosure. Referring to FIG. 1, The method includes: At S101, music signals are acquired.

At S102, the music signals are analyzed, and music analysis content including basic features, change points, beat points, a music structure, music attributes, and a music style is extracted from the music signals.

At S103, control signals are generated based on the music analysis content according to a preset generation rule template, and the control signals are transmitted to a vehicle onboard system to achieve control of vibration and lighting.

In some embodiments, the operation of extracting the music analysis content including the basic features from the music signals, includes:
dividing the music signals into a plurality of music frames, and analyzing and marking predetermined to-be-acquired basic features in each music frame of the plurality of music frames;
where a basic feature \vec{f}ᵢ extracted from an i-th music frame meets:

\vec{f}ᵢ=[f₁(i),f₂(i), . . . ,f_{M}(i)];
M refers to a number of types of the predetermined to-be-acquired basic features;
in response to the music signals including Nf music frames, a set F of the basic features meets:

F=[\vec{f}₁,\vec{f}₂, . . . , \vec{f}_{Nf}].

In some embodiments, the operation of extracting the music analysis content including the change points from the music signals, includes:
determining whether a current music frame includes a change point according to a degree of energy change in time domain or frequency domain of a music frame previous to the current music frame and of a music frame next to the current music frame; and
in response to the current music frame including the change point, extracting the change point from the current music frame; in response to the music signals including No change points, a set O of the change points meets:

O=[o₁,o₂, . . . ,o_{N}_{ₒ}]

In some embodiments, the operation of extracting the music analysis content including the beat points from the music signals, includes:
tracking beats of the music signals using a preset neural network, and marking the beat and downbeats; in response to the music signals including Nb beats and Nd downbeats, a set B of the beats meets:

B=[b₁,b₂, . . . b_{N}_{_{b}}]; and
a set D of the downbeats meets:

D=[d₁,d₂, . . . ,d_{N}_{_{d}}].

In some embodiments, the operation of extracting the music analysis content including the music structure from the music signals, includes:
segmenting the music signals according to structural information of the music signals, to obtain a plurality of music segments; where an i-th music segment \vec{s}ᵢ of the music signals meets:

\vec{s}ᵢ=[t_{begin}(i),t_{end}(i)];
where t_{begin}(i) refers to starting time of the music segment \vec{s}ᵢ, and t_{end}(i) refers to ending time of the music segment \vec{s}ᵢ, in response to there being Ns music segments, a set S of the music segments meets:

S=[\vec{s}₁,\vec{s}₂, . . . ,\vec{s}_{Ns}]; and
in response to a type of the i-th music segment being ki, segment type information K of the music signals meets:

K=[k₁,k₂, . . . ,k_{Ns}].

In some embodiments, the operation of extracting the music analysis content including the music attributes from the music signals, includes:
dividing the music signals into a plurality of music bars, and calculating rhythm intensities based on a respective number of notes played in each music bar of the plurality of music bars; where an i-th music bar \vec{r}ᵢ of the music signals meets:

\vec{r}ᵢ=[t_{begin}(i),t_{end}(i)];
in response to a number of the plurality of music bars being Nr, a set R of the music bars meets:

R=[\vec{r}₁,\vec{r}₂, . . . ,\vec{r}_{Nr}]; and
in response to a rhythm intensity of the i-th music bar being mi, rhythm intensity information M of the music signals meets:

M=[m₁,m₂, . . . ,m_{Nr}].

In some embodiments, the operation of generating, based on the music analysis content, the control signals according to the preset generation rule template, includes:
in response to the music style of the music signals being C, generating the preset generation rule template according to the set R of the music bars, the rhythm intensity information M, the set S of the music segments, the segment type information K and the music style C {R, M, S, K, C};
generating, based on the set O of the change points, the set B of the beats and the set D of the downbeats, time point control signals T for vibration control according to the preset generation rule template;
generating, based on the set F of the basic features and the time point control signals T, vector control signals P for lighting control according to the preset generation rule template; and
outputting the time point control signals T and the vector control signals P as the control signals.

The computer device 300 can implement the operations of the vehicle onboard control method based on multi-level music information as illustrated above, and can achieve the same technical effects. Reference can be made to the above illustration, and will not be repeated here.

Embodiments of the present disclosure further provide a non-transitory computer-readable storage medium, configured to store a vehicle onboard control program based on multi-level music information, which, when executed by at least one processor, causes the at least one processor to perform operations of the vehicle onboard control method based on multi-level music information provided in some embodiments of the present disclosure, thereby achieving the same technical effects, which will not be illustrated here, in order to avoid repetition.

Those skilled in the art should understand that the all or part of the operations of the method provided in the above embodiments can be implemented using relevant hardware instructed by the vehicle onboard control program based on multi-level music information. The program may be stored in a computer-readable storage medium, and when executed, the program may include the operations of the method provided in the above embodiments. The storage medium may be a magnetic disc, an optical disc, a read-only memory (ROM), or a random access memory (RAM), etc.

It should be noted that in the present disclosure, the terms “comprising”, “including”, or any other variation thereof are intended to encompass non-exclusive inclusion, such that a process, method, item, or device that includes a series of elements not only includes those elements, but also includes other elements that are not explicitly listed, or further includes elements inherent to such a process, method, item, or device. Without further limitations, the element limited by the statement “including a . . . ” does not exclude the existence of other identical elements in the process, method, item, or device that includes that element.

With the description of the above embodiments, those skilled in the art can clearly understand that the above methods provided in the embodiments can be implemented using software and necessary general hardware platforms, and of course, also can be implemented using hardware. However, in many cases, the former is a better way of implementation. Based on this, the technical solutions of the present disclosure, which essentially or in other words, parts of which contribute to the existing technologies, can be implemented in the form of a software product. The computer software product is stored in a storage medium (such as ROM/RAM, magnetic disc, optical disc), including several instructions to enable a terminal (which may be a mobile phone, computer, server, air conditioner, or network device, etc.) to execute the methods described in the embodiments of the present disclosure.

The above mentioned are only the embodiments of the present disclosure. It should be pointed out that for those skilled in the art, improvements can be made without departing from the inventive concept of the present disclosure, but these improvements are all within the scope of protection of the present disclosure.

What is claimed is:

1. A vehicle onboard control method based on multi-level music information, comprising:
acquiring music signals;
analyzing the music signals and extracting music analysis content including basic features, change points, beat points, a music structure, music attributes, and a music style from the music signals; and
generating, based on the music analysis content, control signals according to a preset generation rule template, and transmitting the control signals to a vehicle onboard system to achieve control of vibration and lighting.

2. The method according to claim 1, wherein extracting the music analysis content including the basic features from the music signals, includes:
dividing the music signals into a plurality of music frames, and analyzing and marking predetermined to-be-acquired basic features in each music frame of the plurality of music frames;
wherein a basic feature \vec{f}ᵢ extracted from an i-th music frame meets:
\vec{f}ᵢ=[f₁(i),f₂(i), . . . ,f_{M}(i)];
M refers to a number of types of the predetermined to-be-acquired basic features;
in response to the music signals including Nf music frames, a set F of the basic features meets:
F=[\vec{f}₁,\vec{f}₂, . . . , \vec{f}_{Nf}].

3. The method according to claim 2, wherein extracting the music analysis content including the change points from the music signals, includes:
determining whether a current music frame includes a change point according to a degree of energy change in time domain or frequency domain of a music frame previous to the current music frame and of a music frame next to the current music frame; and
in response to the current music frame including the change point, extracting the change point from the current music frame;
in response to the music signals including No change points, a set O of the charge points meets:
O=[o₁,o₂, . . . ,o_{N}_{ₒ}]

4. The method according to claim 3, wherein extracting the music analysis content including the beat points from the music signals, includes:
tracking beats of the music signals using a preset neural network, and marking the beat and downbeats;
in response to the music signals including Nb beats and Nd downbeats, a set B of the beats meets:
B=[b₁,b₂, . . . b_{N}_{_{b}}]; and
a set D of the downbeats meets:
D=[d₁,d₂, . . . ,d_{N}_{_{d}}].

5. The method according to claim 4, wherein extracting the music analysis content including the music structure from the music signals, includes:
segmenting the music signals according to structural information of the music signals, to obtain a plurality of music segments;
wherein an i-th music segment \vec{s}ᵢ of the music signals meets:
\vec{s}ᵢ=[t_{begin}(i),t_{end}(i)];
wherein t_{begin}(i) refers to starting time of the music segment \vec{s}ᵢ, and t_{end}(i) refers to ending time of the music segment \vec{s}ᵢ, in response to there being Ns music segments, a set S of the music segments meets:
S=[\vec{s}₁,\vec{s}₂, . . . ,\vec{s}_{Ns}]; and
in response to a type of the i-th music segment being ki, segment type information K of the music signals meets:
K=[k₁,k₂, . . . ,k_{Ns}].

6. The method according to claim 5, wherein extracting the music analysis content including the music attributes from the music signals, includes:
dividing the music signals into a plurality of music bars, and calculating rhythm intensities based on a respective number of notes played in each music bar of the plurality of music bars;
wherein an i-th music bar \vec{r}ᵢ of the music signals meets:
\vec{r}ᵢ=[t_{begin}(i),t_{end}(i)];
in response to a number of the plurality of music bars being Nr, a set R of the music bars meets:
R=[\vec{r}₁,\vec{r}₂, . . . ,\vec{r}_{Nr}]; and
in response to a rhythm intensity of the i-th music bar being mi, rhythm intensity information M of the music signals meets:
M=[m₁,m₂, . . . ,m_{Nr}].

7. The method according to claim 6, wherein generating, based on the music analysis content, the control signals according to the preset generation rule template, includes:
determining the music style C of the music signals, and generating the preset generation rule template according to the set R of the music bars, the rhythm intensity information M, the set S of the music segments, the segment type information K and the music style C {R, M, S, K, C};
generating, based on the set O of the change points, the set B of the beats and the set D of the downbeats {O, B, D}, time point control signals T for vibration control according to the preset generation rule template;
generating, based on the set F of the basic features and the time point control signals T, vector control signals P for lighting control according to the preset generation rule template; and
outputting the time point control signals T and the vector control signals P as the control signals.

8. A vehicle onboard control system based on multi-level music information, comprising:
a data acquisition module, configured to acquire music signals;
a music analysis module, configured to analyze the music signals and extract music analysis content including basic features, change points, beat points, a music structure, music attributes, and a music style from the music signals; and
a control module, configured to generate, based on the music analysis content, control signals according to a preset generation rule template, and to transmit the control signals to a vehicle onboard system to achieve control of vibration and lighting.

9. A computer device, comprising: a memory, at least one processor, and a vehicle onboard control program based on multi-level music information stored in the memory, which, when executed by the at least one processor, causes the at least one processor to perform operations of a vehicle onboard control method based on multi-level music information, comprising:
acquiring music signals;
analyzing the music signals and extracting music analysis content including basic features, change points, beat points, a music structure, music attributes, and a music style from the music signals; and
generating, based on the music analysis content, control signals according to a preset generation rule template, and transmitting the control signals to a vehicle onboard system to achieve control of vibration and lighting.

10. A non-transitory computer-readable storage medium, configured to store a vehicle onboard control program based on multi-level music information, which, when executed by at least one processor, causes the at least one processor to perform operations of the vehicle onboard control method based on multi-level music information according claim 1.
